(19) United States
(12) Patent Application Publication
(10) Pub. No.: US 2001/0050750 A1
(43) Pub. Date: Dec. 13, 2001

(54) Pinhole presbyopic contact lenses

(76) Inventor: Joseph L. Breger, Highland Park, IL (US)

Correspondence Address: FITCH EVEN TABIN AND FLANNERY, 120 SOUTH LA SALLE STREET, SUITE 1600, CHICAGO, IL, 606033406

(21) Appl. No.: 09/870,083

(22) Filed: May 30, 2001

Related U.S. Application Data
(63) Continuation-in-part of application No. 09/590,207, filed on Jun. 8, 2000.

(51) Int. Cl. G02C 7/04

(52) U.S. Cl. 351/161; 351/160 R

(57) ABSTRACT

A multi-focal simultaneous vision contact lens includes a central vision element and an outer vision element formed in a single, unitary, monolithic body of contact lens material. The central vision element has a diameter less than 2.00 mm. Additional vision elements, such as an intermediate range element, can be included, as well.

### CROSS-REFERENCE TO RELATED APPLICATIONS

This is a continuation-in-part of patent application Ser. No. 09/590,207, filed Jun. 8, 2000 (Attorney Docket No. 68995).

### BACKGROUND OF THE INVENTION

1. Field of the Invention

The present invention pertains to contact lenses and in particular to multi-focal lenses for simultaneously imaging objects at multiple distances (e.g., near, intermediate or far) in a wearer's eye.

2. Description of Related Art

Although the popularity of eyeglasses for use in mono vision correction remains strong, considerable attention has been directed to the use of contact lenses in correcting the more difficult vision problems of presbyopic patients and patients suffering from pathological conditions. The fitting of presbyopic contact lenses has become a specialized field, requiring fitting techniques and highly developed skills not required in other types of contact lens practice.

A contact lens can be fitted so as to remain centered on a patient's cornea or pupil (a so-called “central fit”), or the contact lens can be positioned off-center with respect to the wearer's eye. It is widely recognized that a contact lens is rarely stable in a person's eye and the shifting of the lens with respect to the pupil due to lid and eye movement, for example, has long been recognized.

A so-called “alternating vision” fitting practice relies on a shift in the wearer's eye to move the near and the distant correction portions of the lens with respect to the wearer's pupil. Even with fitting practices which rely on a relatively constant positioning of the contact lens about the wearer's eye, movement of the lens with respect to the pupil must be anticipated. One example of this latter type of fitting practice is the so-called “simultaneous vision” fit in which nearby and distant objects are simultaneously processed by the user, requiring mental differentiation of the resulting multiple images.

One approach for providing a precise fitting is to shape the contact lenses with a “close fit”, closely conforming the curvature of the lens to the curvature of the patient's eye, so that movement of the lens about the eye is restricted. If the curvature of the lens is increased beyond this point, stability is attained at the expense of patient discomfort, and recent studies have indicated problems of inadequate circulation and cleansing and wetting action of tears associated with tighter-fitting lenses.

One type of vision correction that has been attempted over the years is commonly referred to as “pinhole lenses”. These types of lenses have been considered for correction of presbyopia but have been rejected as reducing to an impractical extent, both the field of view and the brightness of the retinal image. These types of lenses are generally regarded as unsuitable, despite costly enhancements such as multi-range features where a central pinhole is surrounded by several radial lines. Although the field of view is improved somewhat, reductions in retinal image brightness are severe, and it is difficult for patients to read in many situations. As is well understood in the field of optics, enlarging the pinhole size to increase image brightness leads to a reduction in image sharpness, or resolution.

Prior art aperture-type pinhole lenses are made from black plastic stock so as to provide a dense black periphery around the pinhole, which is formed by drilling and subsequently filling the lens with clear plastic. Even when the pinhole lens is fitted so as to move with the eye and so as to be very closely positioned with respect to the entrance pupil, the field of view is still greatly restricted compared to other types of presbyopic vision correction. Construction costs are higher than other vision correction lenses, and the resulting performance has been disappointing, especially for normal vision patients who complain of excessive loss of light and non-specific types of visual disturbance. Cosmetic appearance presented by this type of pinhole contact lens has been found to be unacceptable for many patients.

In the construction of prior non-aperture pinhole lenses, the majority of the contact lens is made opaque with only the central pinhole aperture transmitting light. Accordingly, the cosmetic appearance presented by the pinhole contact lens is unacceptable for many patients. As mentioned above, radial lines are sometimes added to the pinhole of an opaque lens to improve peripheral vision. A series of non-opaque radial spokes are provided, emanating from the pinhole. These types of contact lenses present an unacceptable cosmetic appearance. According to work performed in association with the British Optical Association substantial disadvantages of pinhole lenses have been quantified. The diameter of the pinhole aperture is chosen between one and two millimeters according to the near addition. The higher the near addition, the smaller the aperture needs to be in order to provide the patient with acceptable vision correction. It is estimated that a 1.00 millimeter aperture is the equivalent of a very dark tinted spectacle lens. Further, the reduced field of view is estimated to be as little as fifteen degrees depending upon the distance of the lens from the eye's entrance pupil (interior chamber).

Although the pinhole contact lens provides improvement to correct refractive irregularities, especially for patients having irregular eye surfaces, the resulting reduced illumination renders the use of these types of lenses unacceptable in dim light and especially at night.

Because of the drawbacks reported by large numbers of healthy presbyopic patients, other types of vision correction are usually employed, and pinhole lenses are regarded as providing value for patients having low vision due, for example, to distorted pupils, scarred corneas or other impairment to the eye's optical system.

### SUMMARY OF THE INVENTION

It is an object of the present invention to provide a “pinhole” type of contact lens overcoming the difficulties encountered with prior lenses.

Another object of the present invention is to provide a pinhole contact lens of the above type which is made from a unitary contact lens body which is not drilled or filled with external lens components.

A further object of the present invention is to provide a pinhole contact lens of the above type in which the vision correction portions of the lens are formed by cutting, molding or otherwise shaping a lens blank so as to form a central vision correction lens having a diameter ranging between 0.85 and 2.00 mm, preferably ranging between 1 and 1.5 mm and most preferably ranging between 0.85 and 1.75 mm. Either steeper-curve vision correction portions or a flatter-curve vision correction portions are formed on at least one major surface of the contact lens.

These and other objects of the present invention are provided in a multi-focal simultaneous vision contact lens comprising:

a single, unitary, monolithic body of contact lens material having opposed anterior and posterior major surfaces;

a central vision element formed in the center of the body, to provide a first vision correction comprising one of said distance and said near corrections;

an outer vision element formed in the body, so as to surround said central vision element, to provide a second vision correction comprising the other of said distance and said near corrections; and

said central vision element having a diameter preferably ranging between 0.85 and 2.00 mm, and most preferably ranging between 0.85 and 1.75 mm.

### BRIEF DESCRIPTION OF THE DRAWINGS

FIG. 1 is a front elevational schematic view showing one example of a contact lens fitting, according to principles of the present invention;

FIG. 2 is a schematic view showing a second, different fitting of the contact lens;

FIG. 3 is a front elevational view of another contact lens; and

FIG. 4 is a side elevational view of the lens of FIG. 2.

### DETAILED DESCRIPTION OF THE PREFERRED EMBODIMENT

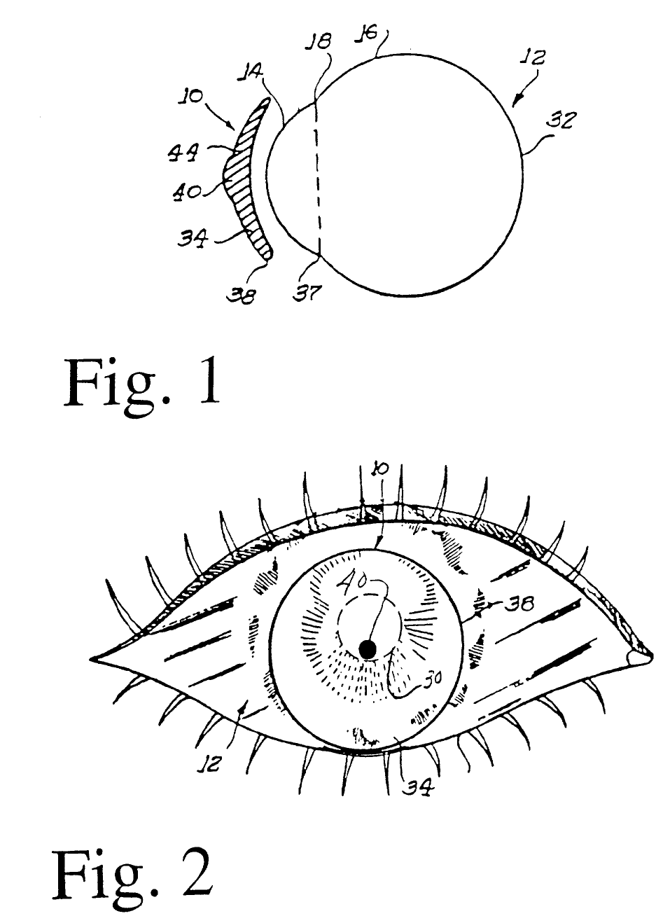

Referring now to the drawings, FIG. 1 shows a contact lens according to principles of the present invention generally indicated at 10 fitted to a human eye, generally indicated at 12. The eye includes a cornea 14 and a sclera 16 joined by a limbal area 18, 37. Images entering the eye through pupil 30 (see FIG. 2) are focused onto retina 32.

Referring to FIG. 2, it can be seen that the contact lens 10 is circular and can be employed in different fitting practices, such as the “low-riding” position shown, wherein the lens is shifted downwardly, below a point of centering about the wearer's pupil. The present invention can be employed with soft as well as hard contact lenses, and is readily adaptable to a wide range of fitting practices, including alternating vision and fixed methods.

Contact lens 10 is of the simultaneous vision, preferably concentric vision type, so as to provide multi-focal correction for presbyopic patients, where images in different vision correction portions of the lens are simultaneously focused in the patient's eye. Lenses according to principles of the present invention may also be used for improved mono-vision fitting practices. For example, central pinhole sized vision elements can be added to traditional mono-vision lenses (one for distance and one for near objects) to provide vision correction at intermediate distances so as to view a CRT display, for example.

The contact lens is without apertures and is preferably constructed to have at least two concentric areas of vision correction, with the central “pinhole” element 40 (or vision correction portion) providing a first (distant or near) power correction, bringing (distant or near) vision objects into focus. A single outer (near or distant) element 34 is illustrated in FIG. 1 as extending to the peripheral curve at the edge 38 of contact lens 10. If desired, concentric annuli can be added to the central and outer portions to provide a vision correction intermediate the near and distant vision prescriptions. For example, aspherical lenses having five or more vision prescriptions can be readily provided in conjunction with the central pinhole sized element 40.

Lenses according to the present invention are made from a single, unitary monolithic blank. Preferably, the lens blank employed is of conventional (transparent) construction and is homogenous throughout. The central vision portion is formed from the lens blank using conventional means, such as numerically controlled lathe cutting. Techniques of this type are proven with respect to soft contact lenses, as well as hard contact lenses. Other conventional techniques, such as molding, or a combination of molding and lathe cutting can be employed, as well. A combination of cutting and molding techniques can be employed, for example, by cutting the base curve on the posterior surface of the lens and thereafter molding required vision correcting portions on the anterior surface of the lens.

According to principles of the present invention, the central vision correction portion of the lens is relatively small, and of a “pinhole” size, although a hole is not drilled or otherwise formed in the lens body 44. Rather, the present invention contemplates integral central vision correction potions formed on the lens surface by cutting or otherwise working the lens surface so as to form the desired vision correction powers. In the preferred embodiment, a CNC or digitally controlled lathe tool is used to work the anterior surface of lens 10 so as to form the appropriate shape. According to principles of the present invention, the central vision correction portion, of whatever power, is sized with a diameter ranging between 0.85 and 2.00 mm, but most preferably ranging between 0.85 and 1.75 mm. The first range covers the widest population of pupil sizes and the last two ranges covers smaller pupil size populations.

Surprisingly, lenses constructed according to principles of the present invention, with integral center portions have been observed to provide improved peripheral vision compared to conventional “pinholes” lenses. Further, deterioration of the retinal image (that is, the observed apprehension of objects) viewed through the central correction portion (either distance or near) is found to be much less than conventional pinhole type lenses. Retinal illumination is also found to be surprisingly improved. With the present invention pinhole contact lenses can be used in lower light levels, and can be successfully employed with the wider range of “normal” patients, as well as low vision patients.

It is believed important (and may be critical, although criticality has not been fully determined at this time) that the transition between the integrally formed central and outer vision correction portions be made as small as practically possible, so that any resulting vision “gap” be virtually indiscernible by the wearer (i.e. the retinal image is made negligibly small). In the preferred embodiment, a cutting tip radius of 0.010 inch was used to form the central portion on the anterior surface of the lens blank. This resulted in a transition “gap” of approximately 0.05 inch radius, and was found to be sufficiently small so as to be imperceptible to the user. Cutting tips of 0.02 inch and 0.03 inch were also used and were found to yield acceptable results, with tip radii of 0.01 and 0.015 inch, respectively.

Because of the small size of the central portion, lenses according to the present invention offer a practitioner a wide range of fitting methods, and have been observed to work very well with multi-focal lenses riding off-center, for example. Lenses according to the present invention work well without a ballast or other anti-rotation features which were necessary with prior pinhole type lenses.

The central vision portion is formed for the optical power desired. For example, referring to FIG. 4, the central portion 40 is formed by lathe cutting the remaining anterior surface 102 of lens body 44. If desired, the central vision correction portion can be formed on the posterior surface 106, although this is generally not preferred due to the added difficulty of the tooling operation, and resulting interference with proper fitting of the lens on the wearer's eye.

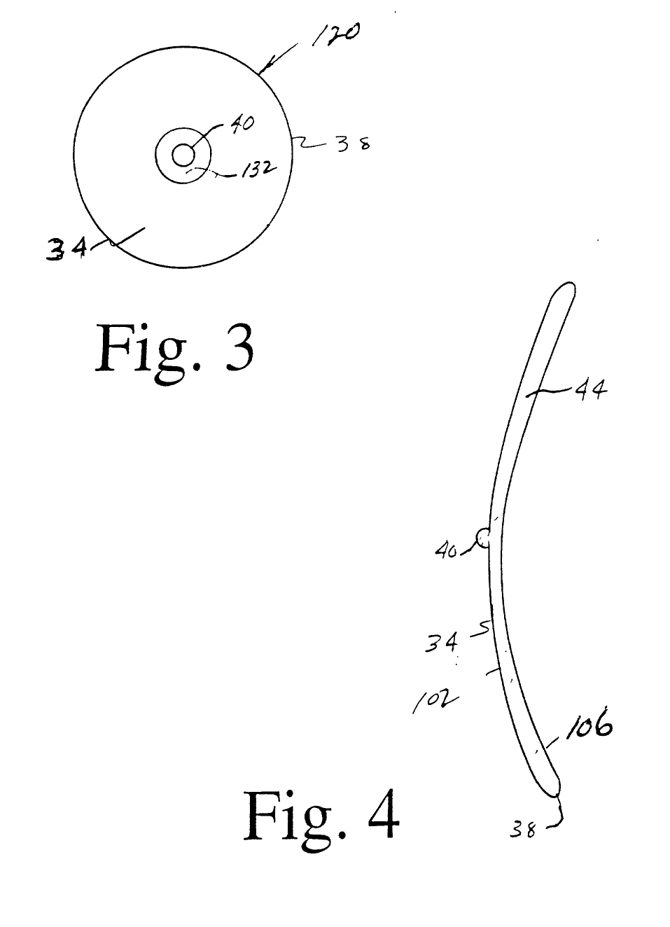

Referring to FIG. 3, the contact lens 120 is provided with a central pinhole portion 40 and an outer vision correction portion 34. An annular band or intermediate vision correction portion 132 lies between central pinhole portion 40 and outer vision correction portion 34.

Lens 120 is provided with three different optical powers in the three vision correction portions. Preferably, three different powers in the vision correction portions resolve images at near, intermediate and far distances, and the optical powers can be arranged in any of the vision correction portions. For example, the central pinhole portion 40 can provide any of the near, intermediate or distant powers needed for a particular patient. The remaining powers would then be provided in either vision correction portion 34 or 132. Although a three element lens has been described, it should be understood that the present invention also contemplates lenses having more (e.g., five) optical zones, with the central zone being formed on one or more surfaces of the lens, but without drilling and filling of the lens body.

According to the present invention, the preferred fitting practice is to provide the center pinhole vision correction portion with a power corresponding to the patient's most demanding requirements. For example, three element lenses fitted for computer terminal operators would have the intermediate pinhole portion provided with an intermediate power (corresponding to a viewing distance for CRT screens), with the remaining distance and near powers being provided in vision correction portions surrounding the central pinhole portion. It is contemplated that the locations of the powers of a lens fitted to one of the patient's eyes is not repeated in the lens for the other patient's eye. For example, some patients may prefer a lens pair in which the central pinhole portion of one lens is shaped for an intermediate power (set, for example, to CRT viewing distances) while the central pinhole portion of the other lens is set for a near power (to accommodate documents viewed at a normal reading distance).

The optics of the central pinhole portions of lenses according to the present invention can be spherical or aspherical and, as pointed out above, can be formed on either major surface of the lens body. Further, as mentioned above, contact lenses according to the present invention can be of the soft lens or hard lens type and further can be a combination of soft and hard lenses. For example, inner portions of the lens can be of the hard lens type whereas outer portions of the lens can be of the soft lens type. However, according to principles of the present invention, the central pinhole portion is formed as an integral unitary part of the lens surface on which it is formed. Accordingly, the central pinhole portion is not formed by filling a pin-sized hole formed in the lens body.

As mentioned above, the powers of the contact lens portions can be formed in either the anterior or the posterior major surface of the lens body, or both. The present invention further contemplates that the posterior surface of a lens can be shaped with a curve which alters some or all of the vision correction portions formed on the anterior surface of the lens, as is commonly employed in constructing “heavy plus” lenses.

The present invention provides substantial advantages for practitioners, such as those treating single vision patients who now require bifocal correction. For example, single vision patients having distance correction lenses are likely, with advancing age, to require an added vision correction element for reading, or otherwise viewing objects at near distances. With the present invention, a bifocal simultaneous vision contact lens can be quickly and easily fabricated for such patients using their single vision contact lens prescriptions. Fabrication of the bifocal lens according to principles of the present invention begins with conventional single vision prescription data including, for example, lens diameter, base curve, distance power, peripheral curves(s), opthalmometer reading and optical zone (diameter of lens minus the size of the peripheral curve(s) specified). According to the present invention, an additional prescription element is added specifying the size and curvature of the “pinhole” central vision element to be added at the center of the previously prescribed single vision lens. Thus, manufacturers of contact lenses according to principles of the present invention can readily accommodate different practitioners' fitting practices and can provide the practitioner with a lens to which the patient has already become accustomed. As a result, patient comfort and confidence in the new, bifocal lens is assured, eliminating the need for revised prescriptions and greatly reducing the chair time needed to accommodate the patient.

The introduction of the central vision element will reduce the amount of single vision information previously made available to the patient. However, because of the small size of the central vision element, the information reduction is not consciously noticed by most patients. Even though the amount of vision information provided by central vision elements according to principles of the present invention is quite small, the added visual information is sufficiently distinctive so as to be readily recognized by the patient.

In the example given above, a distance correction single vision lens is provided with an added “pinhole” sized near vision correction element. This example addresses a common type of patient treatment. However, the present invention also contemplates other types of vision treatment being practiced today. For example, a “pinhole” sized central element configured for correction at intermediate distances can be added to an existing contact lens prescription. One example of an existing prescription would be a single vision distance correction and another example would be a bifocal vision correction prescription in which the interior element has a diameter substantially greater than 1.75 millimeters. Because of the relatively small size of the “pinhole” sized central vision element according to principles of the present invention, the interior bifocal vision correcting portion will not be substantially impacted and the patient's proven tolerance to lens movement will not be substantially reduced. Because of its relatively small size, the “pinhole” central vision element according to principles of the present invention will not detract substantially from the visual information provided to the patient by the interior bifocal element.

It is preferred that the “pinhole” sized central vision correction element be introduced into a contact lens at the time of lens manufacture. However, it will be readily appreciated that the present invention also provides substantial advantages in allowing the central “pinhole” vision correction element to be added to an existing contact lens previously manufactured for a particular patient.

In the various embodiments and examples described herein, an outer vision element cooperates with the central vision element so that the central vision element functions as a true pinhole lens, according to the well known pinhole effect. In a two element bifocal simultaneous vision contact lens, for example, the central pinhole lens provides a substantial increase in depth of field where both distance and near vision rays are in focus on the retina at the same time and resource depth of field to presbyopic patients. The pinhole effect of the central element limits the diameter of a bundle of incoming light, eliminating peripheral light rays and permitting central rays to pass through, with apparitions attributed to peripheral light rays being eliminated. The diameter of the blur circle, caused by various factors such as ametropia, presbyopia or irregular eye surfaces is reduced, and the quality of the retinal image is increased along with increased contrast and clarity of vision.

Contact lenses according to the present invention are very easy to fit, using conventional fitting principles of single vision lenses. In fact, as pointed out above, certain embodiments of the present invention can be understood to comprise a conventional single vision lens with a very small central portion being adapted as a true pinhole lens, requiring only straight forward conventional techniques for construction. Contact lenses according to the present invention do not have a complicated construction nor do they have complications of fitting encountered with other types of bifocals found in the prior art. With applicant's invention there is no measurement required for a segment, no prism ballast, truncation, translation, head movement effects, eye excursion effects, or fitting of a non-dominant eye, and further there are no visual compromises and no elimination of streopics as encountered with monovision and modified monovision fitting. From a lens manufacturers standpoint, contact lenses according to the present invention can be primarily designed as a single vision lens would be, to fit interpalpebral as a single vision lens. With contact lenses according to the present invention, simultaneous bifocal vision with both power zones are maintained before the wearer's pupil at the same time, despite changing conditions. The outer zone is preferably made larger than the wearer's pupil so as to remain in front of the pupil regardless of eye movement, lag or other lens displacement. Due to its very small size, the central element, which provides the second optical power, stays in front of the pupil regardless of eye movement or lens excursions.

Preferably, contact lenses according to principles of the present invention are formed from a single unitary monolithic body of transparent contact lens material. The outer vision element as contemplated by the present invention may literally extend to the physical outer edge of the contact lens. However, it is also contemplated that the outer vision element, while extending to the periphery of the visible, that is vision correcting portion of the contact lens is located within one or more outer surrounding portions of the lens body designed according to conventional principles to address issues other than vision correction, such as fit and wear of the lens body as well as tear management, circulation and other factors.

With contact lenses adapted for sports use, the central distance pinhole lens, in addition to providing extreme distance correction, adds the advantages of pinhole properties mentioned above. Such sports-related lenses according to principles of the present invention eliminate dazzle caused by glare associated with peripheral light rays.

In another example, the outer distance correction portion may be corrected for three diopter distance whereas the central pinhole lens is corrected for a greater, e.g., 3.5 diopter distance. Sports-related contact lenses according to principles of the present invention typically employ two vision correction elements, but additional vision correction elements could be readily provided, surrounding the central pinhole lens.

Contact lenses according to principles of the present invention have been found to make a significant contribution to the field of sports. It is important in many athletic competitions that a participant's vision be especially adapted for quick and accurate visual identification of small objects or small body movements, at a distance. Typically, near vision, especially vision at reading distances does not play a critical factor in a players performance. Accordingly, contact lenses according to principles of the present invention, has several vision correction elements, all of which provide distance vision correction. Preferably, a “pinhole” sized central vision element, as described above, provides correction for extreme distance focusing, while one or more outer surrounding vision correction elements provide a lesser degree of distance correction.

In one example, a two element bifocal contact lens is provided with a central “pinhole” sized vision element and an outer surrounding distance correction element, constructed according to principles described above. However, unlike conventional fittings, both central and outer vision correction elements provide vision correction for distance focusing. For example, the outer vision correction element may provide 20/20 correction with the center vision element providing vision correction stronger than the outer vision correction element, e.g., 20/15 or 20/10 correction.

Heretofore, lenses providing extreme distance correction, (herein, greater than 20/20 correction) generally, have been found to cause mental fatigue, a rising from the brain being forced to focus on objects at an intermediate or near range, as seen through extreme distance lenses. With the present invention, the brain can selectively process on demand vision from either the outer lens with its lesser distance correction, or the central pinhole lens element providing stronger distance correction, thereby reducing mental fatigue. Thus, a sports athlete can track distant action with the outer vision element until sports-related demands require the athlete to take in additional information through the central pinhole lens.

The present invention also includes contact lenses having two or more lens portions of different powers for distance correction, which do not have a “pinhole” sized central portion. For example, contact lenses having a conventional sized central distance correction portion surrounded by one or more outer distance correction portions of powers different from that of the central portion. Although not necessary, it is preferred that the central correctional portion have the strongest vision correcting power, most preferably stronger than 20/20.

The drawings and the foregoing descriptions are not intended to represent the only forms of the invention in regard to the details of its construction and manner of operation. Changes in form and in the proportion of parts, as well as the substitution of equivalents, are contemplated as circumstances may suggest or render expedient; and although specific terms have been employed, they are intended in a generic and descriptive sense only and not for the purposes of limitation, the scope of the invention being delineated by the following claims.

What is claimed is:

1. A multi-focal simultaneous vision contact lens comprising:
a single, unitary, monolithic body of transparent contact lens material having opposed anterior and posterior major surfaces;
a central vision element formed in a central surface portion of the body as an integral portion thereof, to provide a first distance vision correction of a first optical power;
an outer vision element formed in a surface portion of the body, so as to surround said central vision element, to provide a second distance vision correction of a second optical power; and
said central vision element having a diameter no greater than 2.00 mm.

2. The contact lens of claim 1 wherein said central vision element has a diameter ranging between 0.85 and 1.75 mm.

3. The contact lens of claim 1 wherein said central vision element has a diameter ranging between 1 and 1.5 mm.

4. The contact lens of claim 1 wherein said central vision element has a diameter ranging between 0.9 and 1.1 mm.

5. The contact lens of claim 1 wherein said body of contact lens material is homogenous throughout.

6. The contact lens of claim 1 wherein said central vision element provides distance vision optical power greater than that of said outer vision element.

7. The contact lens of claim 1 wherein said central vision element provides optical power greater than 20/20.

8. The contact lens of claim 7 wherein said outer vision element provides optical power of approximately 20/20.

9. The contact lens of claim 1 wherein at least one of said outer and said central vision elements is formed on the anterior surface of said lens.

10. The contact lens of claim 1 wherein at least one of said central vision element and said outer vision element is formed on the posterior surface of said lens.

11. The contact lens of claim 1 further comprising a third vision element, providing distance vision correction of a third optical power.

12. The contact lens of claim 1 wherein said central element and said outer element is formed by shaping said body by cutting, or by molding or both.

13. A multi-focal simultaneous vision contact lens comprising:
a single, unitary, monolithic body of transparent contact lens material having opposed anterior and posterior major surfaces;
a central vision element formed in a central surface portion of the body as an integral portion thereof, to provide a first distance vision correction optical power;
an outer vision element formed in a surface portion of the body, so as to surround said central vision element, to provide a second distance vision correction optical power;
a third vision element providing a third distance optical power; and
said central vision element having a diameter no greater than 2.00 mm.

14. The contact lens of claim 13 wherein said central vision element has a diameter ranging between 0.85 and 1.75 mm.

15. The contact lens of claim 13 wherein said central vision element has a diameter ranging between 1 and 1.5 mm.

16. The contact lens of claim 13 wherein said central vision element has a diameter ranging between 0.9 and 1.1 mm.

17. The contact lens of claim 13 wherein said body of contact lens material is homogenous throughout.

18. The contact lens of claim 13 wherein said central vision element, said outer vision element and said third vision element are formed on the anterior surface of said lens.

19. The contact lens of claim 13 wherein said central element, said intermediate element and said outer element are formed by cutting, or by molding or both.

20. A multi-focal simultaneous vision contact lens comprising:
a body of transparent contact lens material having opposed unitary, monolithic anterior and posterior major surface portions;
a central pinhole vision element formed in a central part of one said major surface portion as an integral portion thereof, to provide a first distance vision correction optical power;
an outer vision element formed in a surface portion of the body, so as to surround said central pinhole vision element, to provide a second distance vision correction optical power; and
said central pinhole vision element having a diameter no greater than 1.75 mm.

21. The contact lens of claim 20 wherein said central vision element has a diameter ranging between 0.85 and 1.75 mm.

22. The contact lens of claim 20 wherein said central vision element has a diameter ranging between 1 and 1.5 mm.

23. The contact lens of claim 20 wherein said central vision element has a diameter ranging between 0.9 and 1.1 mm.

24. The contact lens of claim 20 wherein said body of contact lens material is homogenous throughout.

25. The contact lens of claim 20 wherein said central vision element provides distance vision optical power greater than 20/20.

26. A method of fitting a presbyopic patient for multi-focal vision correction, including the steps of:
providing a transparent contact lens body having opposed anterior and posterior major surfaces;
forming a center distance vision element in at least one of the anterior and posterior major surfaces of the body;
forming an outer distance vision element in at least one of the anterior and posterior major surfaces of the body; and
dimensioning the center vision element so as to have a diameter no greater than 2.00 mm.

27. The method of claim 26 wherein said central vision element has a diameter ranging between 0.85 and 1.75 mm.

28. The method of claim 26 wherein said central vision element has a diameter ranging between 1 and 1.5 mm.

29. The method of claim 26 wherein said central vision element has a diameter ranging between 0.9 and 1.1 mm.

30. The method of claim 26 wherein said body of contact lens material is homogenous throughout.

31. The method of claim 26 further comprising the step of forming an intermediate vision element in at least one of the anterior and posterior major surfaces of the body.

32. The method of claim 31 wherein said center vision element, said outer vision element and said intermediate vision element provides vision correction to distant objects and said center vision element provides the strongest vision correction.

33. The method of claim 26 wherein said steps of forming a center vision element and forming an outer vision element comprise cutting said contact lens body, or molding said contact lens body, or both.

34. A method of fitting a presbyopic patient for simultaneous vision correction, including the steps of:
acquiring single vision prescription data including lens diameter, base curve, distance power, peripheral curve, opthalmometer reading and optical zone of the single vision lens;
fabricating a contact lens according to the single vision prescription data; and
forming a central pinhole vision correction element in at least one of the anterior and posterior major surfaces of the contact lens so as to have a diameter no greater than 2.00 millimeters.

35. The method of claim 34 wherein said steps of fabricating the single vision lens and forming the pinhole center vision element in the lens comprise one of said cutting and said molding of a contact lens body, or both.

36. A method of fitting a presbyopic patient for simultaneous vision correction, using a contact lens of the patient having at least one vision correction element, comprising the step of forming a pinhole center vision element in at least one of the anterior and posterior major surfaces of the body of the contact lens so as to have a diameter no greater than 1.75 millimeters.
